(19) United States
(12) Patent Application Publication
(10) Pub. No.: US 2007/0170239 A1
(43) Pub. Date: Jul. 26, 2007

(54) Self contained portable data management key

(76) Inventors: Shawn P. Hartman, Port Hueneme, CA (US); Alexander Kowblansky, Santa Barbara, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/409,225

(22) Filed: Apr. 20, 2006

Related U.S. Application Data
(60) Provisional application No. 60/675,527, filed on Apr. 27, 2005.

(51) Int. Cl. G06F 17/00; G06K 5/00

(52) U.S. Cl. 235/375; 235/380

(57) ABSTRACT

A portable device that stores medical information of a user is configured via a centralized medical records repository. The portable device includes a data storage that includes a first storage area which stores the medical information corresponding to the user and second storage area that stores a program product. The program product is generated by the centralized medical records repository. The program product configured to execute in a processor of a host system in response to the device being inserted into a memory reader port of the host system and render a graphical user interface to present on a screen communicatively coupled with the host system the stored medical information. In addition, the program product prevents altering of the stored medical information, but does store additional information in a third area of the data storage in response to receiving data inputted from the host system.

### CROSS REFERENCE TO RELATED APPLICATIONS

This application claims the benefit of U.S. Provisional Application No. 60/675,527, filed Apr. 27, 2005, which is incorporated by reference in its entirety.

### BACKGROUND

1. Field of Art

The present invention generally relates to the field of portable data transport for electronic commerce, networked record services, and information storage, retrieval, and processing, for example, in medical record services and telemedicine.

2. Description of the Related Art

A reliable, focused medical record is the cornerstone of effective health care. The medical records departments facilitate patient care by documenting the patient's baseline medical history and provide health care providers with the clinical data that is necessary to detect and treat medical problems in all stages of development and disease progression. Having a detailed set of medical documents and medical images pertinent to a patients history and condition is a vital tool in the future of patient care.

Today, medical records typically are stored in a paper format. The physician maintains a medical or dental chart on the patient. Thus the patient has multiple charts with a number of physicians. All of the charts contain visit summaries, vaccination records, laboratory results, radiographic dictations and current prescriptions. The patients multiple charts are rarely combined and summarized. This results in a large amount of medical information the patient is not aware of thus resulting in the possible repetitive treatment.

In addition, patients medical and dental records in paper format suffer from unstructured, disorganized, and improperly sorted medical and dental information. This results in the ineffective ability to retrieve the information from the dental and medical records in an emergent situation.

With recognition to the drawbacks to paper-based medical and dental records the industry is changing the system to networked medical and dental records. However, this has caused a new set of problems, including lack of connection in some geographic regions, security risks from network hacking, and interruption of network services. Such issues are particularly problematic when there is an immediate need for patient data.

Thus, from the above, there is a need for a system and process to store, access, and manage medical records in electronic format without compromising the information therein.

### SUMMARY

Embodiments disclosed include a self-contained personal information data configuration with automated application execution. In one embodiment the application provides rapid emergent medical information, for example, to emergency medical technicians, paramedics, nurses, doctors and hospitals, doctors offices, government agencies, insurance providers, school systems, travel agencies, retirement homes and day care establishments. Further, the embodiments include a system and method for creating, scanning, storing, accessing and distributing patient medical records to a portable flash drive device.

An embodiment of the present invention includes a portable device that stores medical information of a user and is configured via a centralized medical records repository. The portable device includes data storage areas that include a first storage area which stores the medical information corresponding to the user and second storage area that stores a program product.

The program product is generated by the centralized medical records repository. The program product is configured to execute in a processor of a host system in response to the device being inserted into a memory reader port of the host system and render a graphical user interface to present on a screen communicatively coupled with the host system the stored medical information. In addition, the program product prevents altering of the stored medical information, but does store additional information in a third area of the data storage in response to receiving data inputted from the host system.

One embodiment of the present invention also includes a centralized medical information repository. The centralized medical information repository is configured to set up user accounts. Associated with each user account is medical information corresponding with a user. The medical information includes medical data typically entered into a medical information system, for example, through a hospital or a physician office where the user received medical services. The medical information also includes original medical imaging data, for example, x-rays and CAT scans. In addition, the medical information includes images of original documentation completed by physicians and other medical personnel during the course of providing patient services.

The medical information is encrypted, secured and integrated with a self-executable program product. The program product also is configured to receive and store additional medical information that is later input, but that does not alter the encrypted and secured contexts already integrated with the program product. The program product is then installed on a portable device (or key). The portable device (or key) is structured for use with a memory reader port. Examples of a portable key include a universal serial bus drive or a flash memory card.

The present invention beneficially provides a system in which original medical information is placed on a key device so that a user may keep that key device with them. By including data directly from medical organization originated sources, e.g., hospitals or physician offices, risks associated with improper keying of data is reduced or eliminated. In addition, by having original medical images and original document images on the key device provide first responders and other subsequent tending medical personnel quick access to vital medical information once they have access to the key device. Moreover, encrypting and securing all original data on the device reduces or eliminates risks of inadvertent or malicious alteration of such information and helps ensure overall data integrity for all.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

Figure (FIG.) 1 illustrates one embodiment of medical information management workflow process in accordance with the present invention.

FIG. 2 illustrates one embodiment of a key generation architecture in accordance with the present invention.

FIG. 3 illustrates one embodiment of a functional process for a self contained medical management program in accordance with the present invention.

FIG. 4 illustrates one embodiment of a self contained medical management program architecture within a portable device in accordance with the present invention.

FIGS. 5a-5d illustrate example screen shots displayable on a computer screen inn accordance with one embodiment of the present invention.

### DETAILED DESCRIPTION

The Figures (FIGS.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Generally, the disclosed embodiments describe a self contained medical management system and method. The system and method include a business model and a device (or key) configured to include a medical management program and actual medical data associated with a patient (a user or customer) associated with the device.

Turning now to Figure (FIG.) 1, it illustrates one embodiment of medical information management workflow process 101 in accordance with the present invention. The process includes communications between a customer (or patient or user) 110, a medical information management system 112 (112a, 112b) and a medical professional system (not shown) (e.g., a doctor's office, a dentist's office, a medical clinic, a dental clinic, a hospital, or the like). In one embodiment, the process starts with the customer (patient) 110 contacting the medical information management system 112 to obtain a device configured to include a self contained medical management program and corresponding original documentation images and data (including original medical professional system image and data copies) records.

In one embodiment, the patient 110 optionally contacts a customer service agent (person or system) for intake 115 or a reception agent for intake 145 of data from the patient 110. At this stage in the process, demographic data is collected corresponding to the patient. The information is stored in a customer information database 150. The received information is sent through a quality control 120 sub process where the collected information is verified for accuracy and completeness. If questions or an update are identified in the intake 115 or if the quality control subprocess 120 generates questions or comments, the process includes an inquiry 125 subprocess that addresses these. The inquiry subprocess 125 may be managed through an individual or may be an intelligent system configured to address the raised issues or generate the appropriate response to the update. Example of an intelligent system include a menu driven application that provides responses to, for example, frequently asked questions or provides further processing or guidance for frequently requested actions (e.g., update of record data).

In one embodiment, a method and a system includes a portable device configured to function as a personal information key. The personal information key may be obtained by a patient (user) from a source (e.g., a physician, hospital, third-party company, etc.) that can assist with configuring the personal information key. For example, the user may be asked to complete medical, dental, or other personal information related forms (electronically (e.g., online, standalone, or phone) or through paper) that requests and integrates such information with the personal information key. Retrieval of such data from the user may also include a release of liability.

It is noted that the personal information may include demographic information that can be provided directly from the patient (user) through a form, e.g., an online form or via a telephone questionnaire. In addition, this information may include a release of medical and dental information that may pre-authorize release of data to predetermined health care providers, including particular hospitals and health care provider's offices.

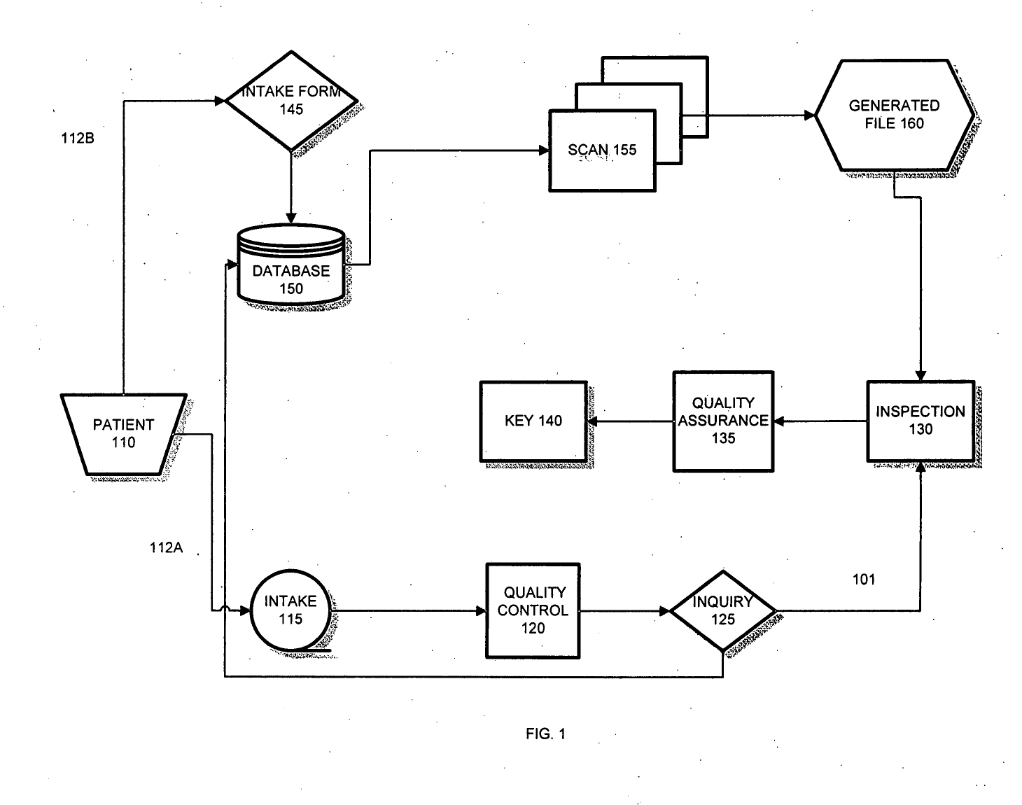

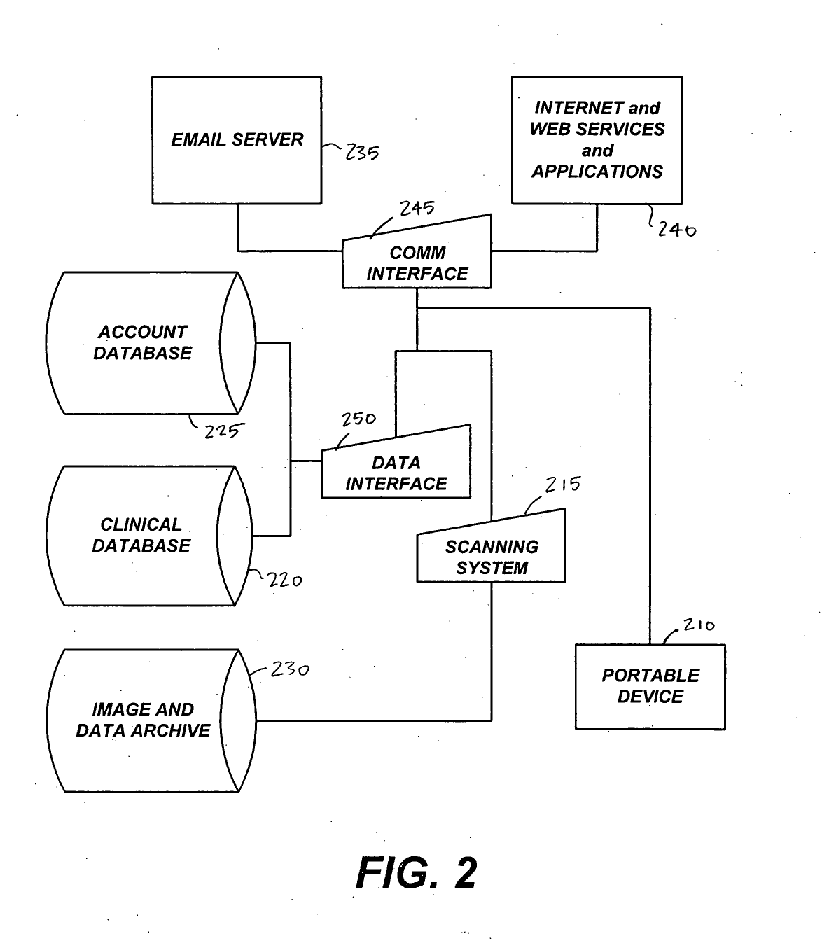

Once the intake 115, quality control 120, and open inquiries 125 are addressed, the process generates a key 140. FIG. 2 illustrates one embodiment of a key generation architecture in accordance with the present invention. The key generation architecture may be structured within the medical information management system 112. It is noted that in one embodiment, the key comprises a portable device 210 configured to include computer readable program instructions to perform functionality as disclosed herein. The portable device 210 may be, for example, a solid state flash memory storage device (e.g., a Universal Serial Bus (USB) “thumb” drive or a flash memory card) or a small form factor magnetic storage disk drive.

The computer readable program instructions includes instructions that allow interoperability (e.g., data transfer, sending or receiving instructions, etc.) with other computing programs, devices, and/or peripherals. For example, the instructions are configured for enabling communications with a scanning device (or system) 215, a digitizer (not shown), a clinical database 220, an account database 225, an image and data archive system 230 and an electronic mail server 235. The instructions also can be configured to enable communications with Internet and web services 240, which could include access to an Internet service provider (which may include web page services), a web enabler, and Internet based software for downloading, interfacing and updating data on the portable device 210. The instructions also are configured to enable communication with a computing system, a printer, a copier, a portable scanner (e.g., a bar code labeling device), and/or radio frequency (RF) reader (e.g., for use with RF tags) (not shown). The various systems and devices are communicatively coupled through appropriate communication interface(s) 245 and data interface(s) 250.

It is noted that the scanning system 215 will be a device capable of scanning original medical and dental records and converts (or generates) digital images of those records (illustrated in FIG. 1 with respect to scanning 155 the documents). The original records include original documents, original computer generated monitoring output, and original images. Examples of original documents include, for example, handwritten forms or notes or computer printed completed forms completed by medical personnel and or patients. Examples of computer generated monitoring output include, for example, electro cardiograms readings, blood test readings, and the like, particularly, if they include additional data in the form of hand marked information. Examples of original images include, for example, x-rays, CAT scans, and the like, particularly, if they include additional data in the form of hand marked information.

In addition, the communication interface 245 and the data interface 250 are configured to communicate with the medical professional system in a second embodiment of the medical information management system 101. Communications in this embodiment is through the email server 235 and/or the Internet and web services 240 to retrieve import in data entered at the medical professional system, e.g., in a medical practice management system. Examples of data to be imported include EKG data, laboratory work data, radiographic information, demographic emergent data (e.g., name, birth date, address, driver license, blood type, allergies, picture), and the like. In addition, the system can be configured also to retrieve the documents that would otherwise need to be scanned, for example, original images and original scanned documents that were previously scanned or otherwise electronically saved through the medical professional system. This demographic emergent data also may be retrieved through input directly from a patient (or user) through, for example, a web form or a telephone form (operator assisted data entry or tele-prompted) 145 (this information is illustrated in FIG. 1 as part of the customer information database 150).

The clinical database 220 stores the scanned medical and dental documents and images, including those retrieved from the medical professional system. The account database 225 is configured to create a record corresponding to the patient and stores the retrieved emergent demographic information within the record (shown in FIG. 1 as the generated 160 file for routing to inspection 130 and quality assurance 135 as further described below). The record also includes financial and billing information for the services rendered. In addition, the record includes a pointer or other link with images corresponding to the patient that are stored in the clinical database 220.

A digitizer encodes the medical images into a format that is accessible for viewing on a computer screen. The image and data archive 230 provides secured storage to store the medical and dental scanned documents and images. This information can be used, for example, to create a new portable device at patient request if the original device is misplaced or lost. The archived data allows for re-issuing a new device with the identical data since the last update to the consumer.

The email server 235 provides communication functionality, for example, between the patients and the medical information management system 112 services. Information such as questions, billing statements, invoices, product shipment demographics, and general questions and comments may be managed through the email server 235. The Internet and web services 240 is configured to provide web page services to conduct communications involving the service, for example, data retrieval and/or data entry of information by a patient through a secured communication link, e.g., a secured socket layer (SSL) connection.

It is noted that the actual storage space of the portable device 210 can be configurable to change in size, if needed. The computer system may be configured as a primary source of interfacing between the scanner and the portable device 210. The printer will be used in conjunction with the computing system to print the correspondences required for the inventions transactions with the consumers to be within the scope of practice. This can be related to privacy related laws such as HIPPA and the Privacy Act of 1974. The copier will be utilized in conjunction with computing system and/or the printer to optionally produce legible copies of documents and images to be pre scanned and the final scan to the portable flash drive device. The copier will not be limited to these above mentioned functions alone. The copier will also be used for business related processes.

The Internet based software for downloading, interfacing and updating data on the portable flash drive device will be utilized by the system and other peripherals (e.g., printer, copier, scanner, etc.) to include the inventions updates and new releases of products with services and monthly, bimonthly, quarterly, annually, or at the consumers request. The scanner and bar code labeling device is configured to mark each portable device 210 shipped to ensure proper replacement in the event of loss and to update the portable device 210 either via remote application or by company based update. This device bar code numbers is configured to be includes with the patient record stored in the account database. It is noted that other unique identifiers to associate patient records with their respective portable device 210 also can be used, for example, chip etched identification numbers, secured radio frequency tags, and serial numbers.

Once the data is within the medical information management system 112 databases and archives, the system is configured to “upload” (installed) the data onto the portable device 210. In addition, the system installs an application configured to secure the information and provide appropriate application programming interfaces to open and read the data directly from the portable device 210. In particular, the portable device 210 stores the patient medical and dental data, which may include raw data, documents, and images. This data may be made available at the patient's volition, for example, to allow healthcare providers to gain access to, view and use, the medical and dental data and images in the event of and emergent situation. It is noted that the records (e.g., documents, images, etc.) may be encrypted prior to transfer and storage in the portable device 210.

The portable device 210 with the user data (including raw data, documents, and images) and executable application program product allows the patient data to be viewed upon insertion or interfacing with a computing system structured to receive the portable device 210, e.g., a USB port.

Referring back to FIG. 1, the received information is configured on the portable device 210, it passes through the quality assurance sub-process 135. The quality assurance sub-process 135 includes having the device tested and the information reviewed by trained professionals, e.g., a staff of medical professionals, to verify the data and its usability. After the transferred data is checked for stability and accuracy, additional releases may be applied, for example, a release form indicating the information on the portable device 210 is to be used only for reference and not as a directed route for patient care.

Once quality assurance is completed, the portable device 210 configured with the appropriate application and data is shipped to the patient 110. In one embodiment, the portable device 210 is shipped with a serialized tracking number with a delivery conformation and signature requirement. A serialized tracking number helps protect the integrity of the device and information within.

As noted, the present invention also includes a method and a system for the portable device 210 to emulate a compact disc (CD) or DVD type drive. For example, the portable flash drive (or “thumb drive”) includes software that interacts with the input port (e.g., USB, Firewire, Bluetooth, etc.) and host system to have the host system operate with the portable device 210 as if the portable storage device was a CD or DVD type drive. In this configuration, the program product that includes the patient information is able to launch upon interfacing with a computer system regardless of operating system because the program product functions as a self contained executable.

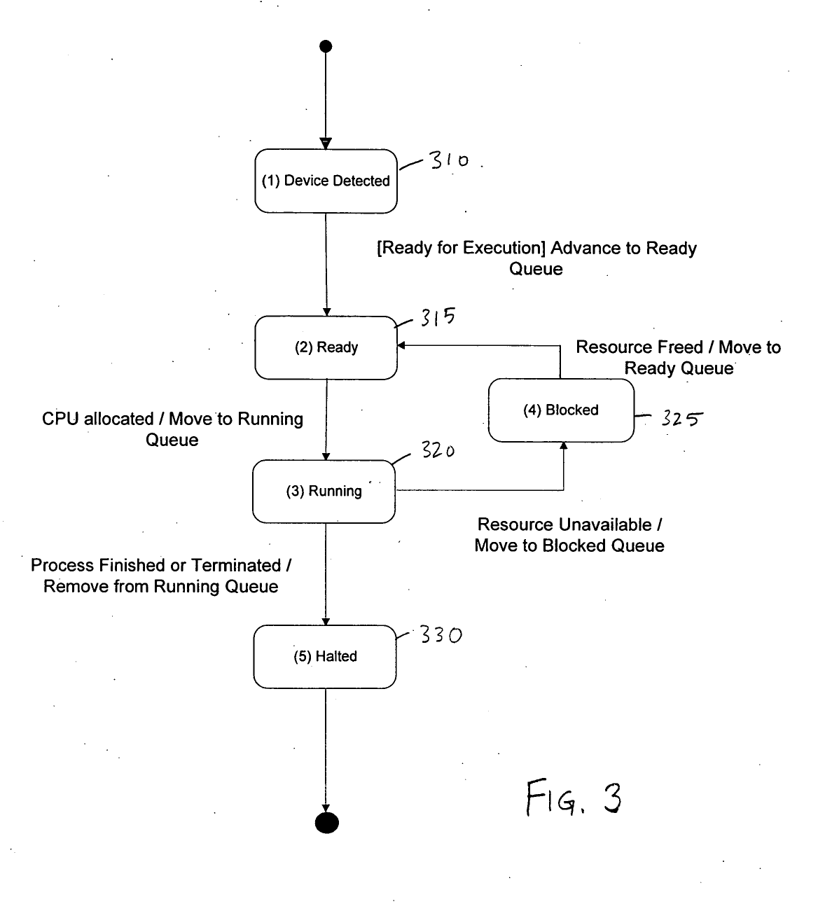

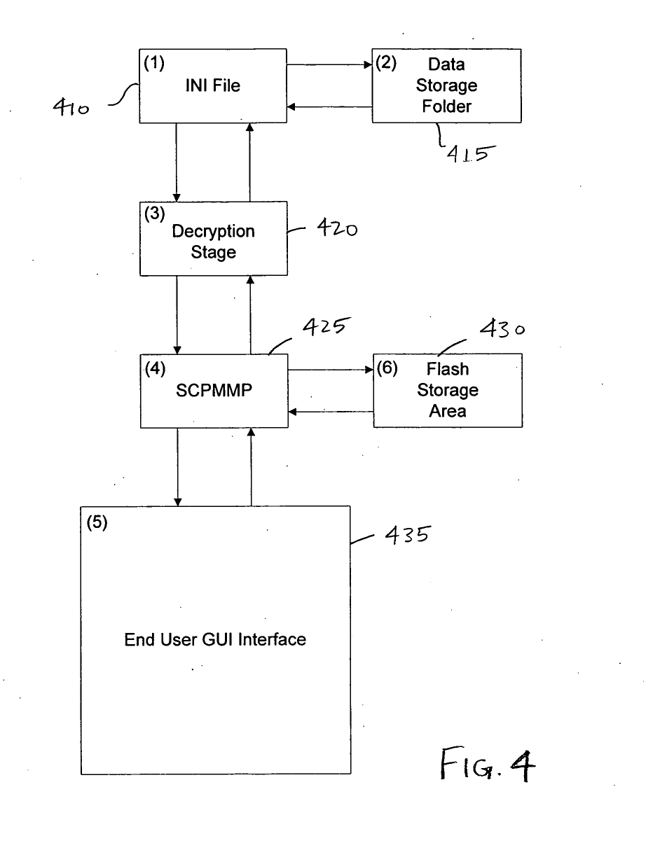

Moreover, the product is executable directly from the portable storage device because the host computer system identifies the portable storage device as a CD or DVD system rather than a portable storage device (e.g., a flash or micro drive). This functionality is particularly advantageous for allowing the portable device 210 to be self contained and operational when used with another computing system that may not include an application configured to open and permit viewing and interaction with the patient documents and images on the portable device 210. The self contained application and process is further described with respect to FIG. 3 and FIG. 4.

Referring now to FIG. 3, it illustrates one embodiment of a functional process for a self contained medical management program in accordance with the present invention. In particular, FIG. 3 illustrates an example of a self executing medical program product for a medical management program. In one embodiment, the process starts with the insertion of the portable device 210 into a computing system configured to communicatively couple with the portable device 210. For ease of discussion, the example embodiment will be described in the context of a portable device 210 having a USB interface.

When a USB connection of the portable device 210 is plugged 310 into a computing terminal (or system) available USB port, the operating system of the receiving computing terminal identifies the USB hardware and firmware. The operating system sets to a ready status 315 for execution, thus advancing the process to a ready queue status. In the ready status 315, the medical management program waits for a drive assignment from the computing terminal. After identifying the drive assignment, the medical management program begins execution, utilizing only the operating system, processor and memory of the computing terminal but no other resources. Moreover, the medical management program is controlled by the application executed from the portable device 210. This application includes and image viewer and algorithms to decrypt any encrypted files within. Additional details on execution of the program (application) are described below with respect to FIG. 4, for example with the self-contained medical management program 425 that will be executed once the appropriate resources are made available.

When the computing terminal resources are unavailable, the process is configured to hold in a blocked queue and continues to loop 325 until active the minimum resources are made available. When the minimum resources is freed the process advances to the ready queue 315 before continuing again. The medical management program continues to execute (run) until the portable device 210 is removed or the medical management program is halted 330, for example, by the end user clicking on the exit button. It is noted that in one embodiment, the system may be configured to only permit exit of the program when the portable device 210 is inserted in the USB Port on the computing terminal.

FIG. 4 illustrates one embodiment of a self contained medical management program architecture within the portable device 210 in accordance with the present invention. In this example embodiment, the architecture includes a configuration file 410 (e.g., an INI file), a data storage folder 415, a decryption stage 420, a self contained medical management program executable 425, a flash memory storage area 430 and an end user graphical user interface 435. The configuration file 410 is stored in the data storage folder 415. The configuration file 410 communicatively couples with the decryption stage 420. The decryption stage 420 communicatively couples with the medical management program executable 425. The medical management program executable 425 is structured for storage within the secure memory storage area 415.

The medical management program executable 425 is communicatively coupled with an end user graphical user interface (GUI) 435. The medical management program executable 425 executes in response to the portable device 210 communicatively coupling a receiving device (computer system) which allocates resources to execute the program as noted, for example, in FIG. 3 above. In one embodiment, the program is begins execution once the portable device 210 is detected (e.g., via the USB hardware and firmware mechanisms) and resources (e.g., drive assignment) are allocated.

The configuration file 410 is structured for use by the medical management program for primary configuration at runtime. The configuration file 410 provides a map for the medical management program to identify where the patient record files (e.g., documents, images, etc.) are located within the data storage folder 415 within a storage on the portable device 210. The configuration file 410 can be manipulated to provide a variety of views from within the medical management program. This is accomplished without changing any of the medical management program basic features. Thus, the configuration file 410 can be structured to permit alternation for providing a different look or feel for an end user.

The data storage folder 415 is configured to store medical management program records. As noted previously, select or all records may be stored within the data storage folder 415 in an encrypted format. The data storage folder 415 is accessed via the configuration file 410 by the medical management program executable 425 at runtime. The configuration file 410 directs the medical management program as to where to retrieve the image files within the data storage folder 415. It is noted that in one embodiment data in the data storage folder 415 may be structured to reside within a secure area 415 of the storage within the portable device 210, which the operating system of the computing terminal recognizes as a non-rewritable area. This structure prevents the rewriting or manipulation of already the stored data, thereby maintaining integrity of records (data).

The decryption stage 420 is, one embodiment, an embedded module that communicatively couples with the medical management program executable 425. The decryption stage 420 decrypts the encrypted image files as they are selected by the medical management program executable 425 from the data storage folder 415. In alternative embodiments, all images or groups of images from the data storage folder 415 that are selected by the medical management program executable 425 may be decrypted together.

The medical management program executable 425 is a self-contained program. Thus, when executing on the system with which it couples, all functionality for accessing, viewing, and interacting with records are with the information in the portable device 210. No application resources on the host are needed for the self-contained program to function. Examples of functions of the medical information management executable 425 include the decryption, image viewer, and the text entry area. Moreover, the medical management program also can be configured to receive and store additional data entered via the computing terminal in a separate data storage folder in the storage on the portable device 210. This entered information can later be synchronized with the patient folder in the account database 225 of the medical information management system 112.

The synchronization can occur manually, e.g., user mails back key, or electronically, e.g., transmission of the updated information via a secured connection from the location where the update occurred directly back to the host system where the keys are centrally managed. Alternatively, the system can be configured so that the user can upload the information directly from the key at their own system by plugging the key into their system and having the key automatically set up a secured communication with the host system to upload the updated data. This may be configured via a sub-program that allows the user to launch an “update” application anytime data on the key has changed, but not yet been synchronized. The “update” application (also available to the location that updated the data) is a preconfigured communications application that includes the appropriate uniform resource locator (URL), file transfer protocol (FTP), or numerical internet protocol (IP) address of the host system server that is configured to receive the update. The application is configured also to transmit the appropriate key identifier (and patient identifier) information and updated information directly to one or more servers at the medical information management system 112 without any further interaction needed by the user.

Separately, the process also may include additional security measures such as two-factor authorization to update the information on the key as well as update the information on servers at the medical information management system 112. Other security measures that may be integrated include biometric type security measures.

Continuing with FIG. 4, the end user GUI 435 comprises a GUI based program allowing for interaction by the end user (at the computing terminal) to the data stored within the portable device 210. The GUI 435 includes an interactive area that is directory and sub directory based allowing for the ease of retrieval, decryption, and viewing of the data in a logical and intuitive format. The viewing entry form includes a text entry area which writes the notes entered by the end user into a text (txt) format and stores them on the flash portion 430 of the device. All of the current data and files, separate from the txt notes entered by the end user, are tamper proof.

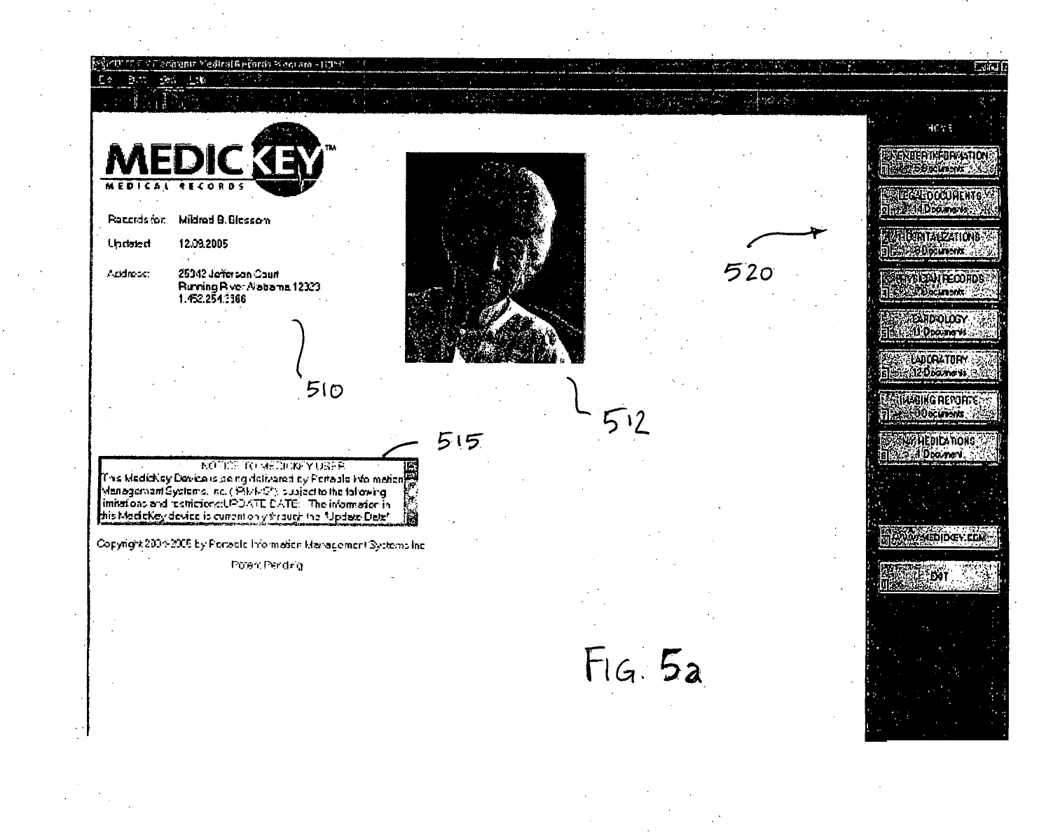

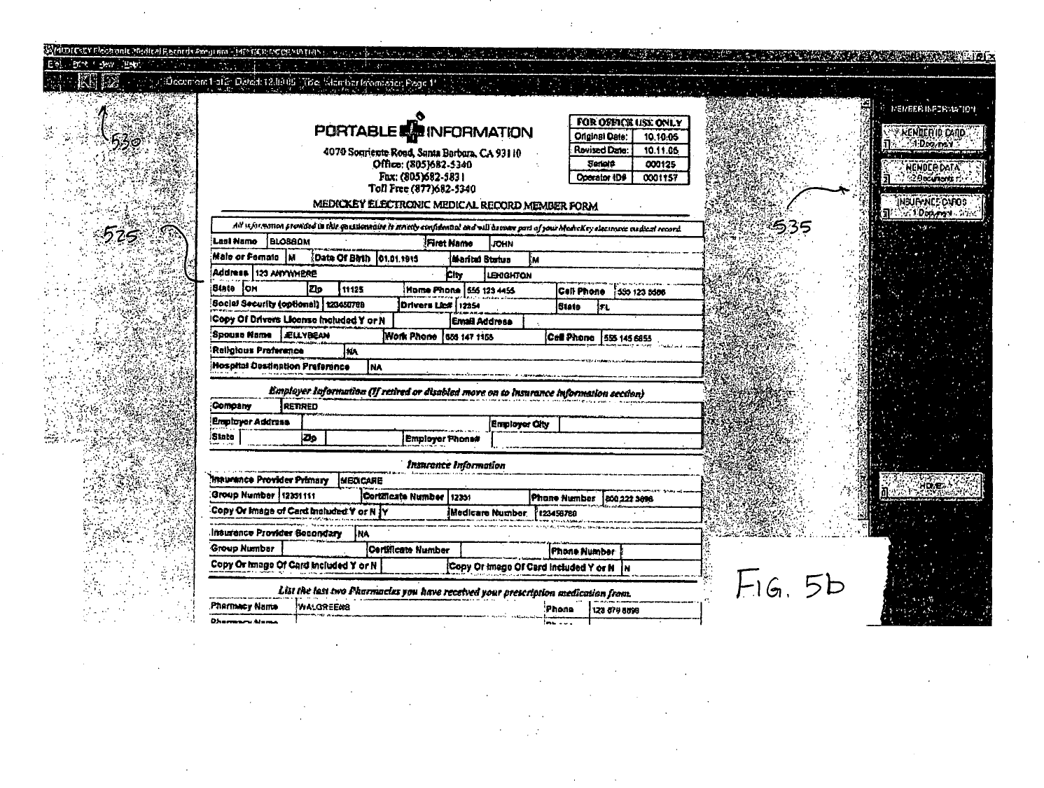

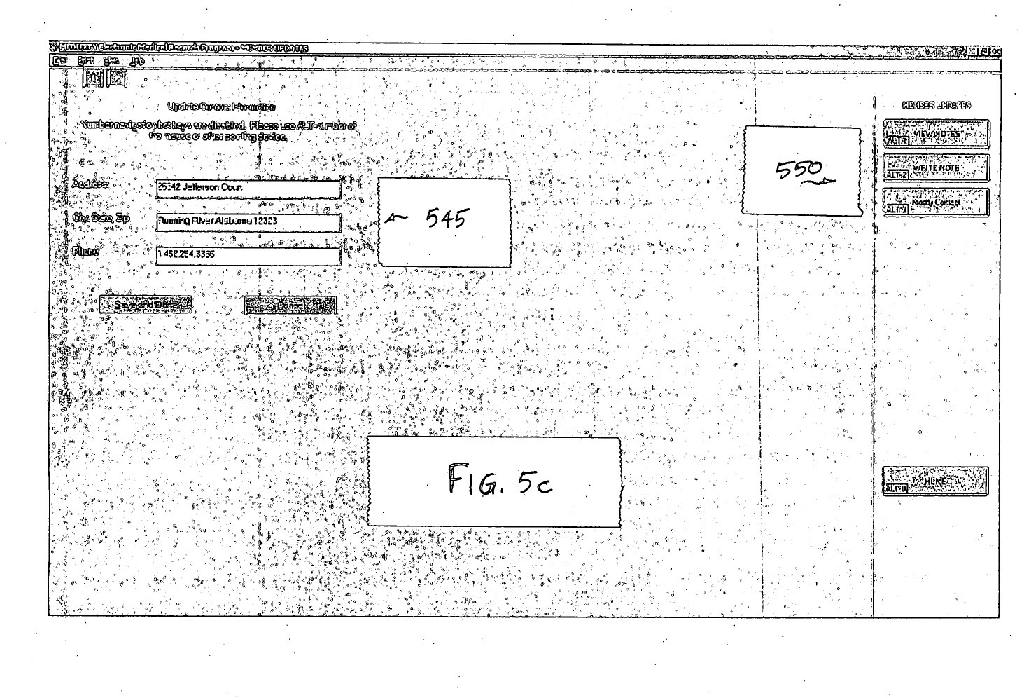

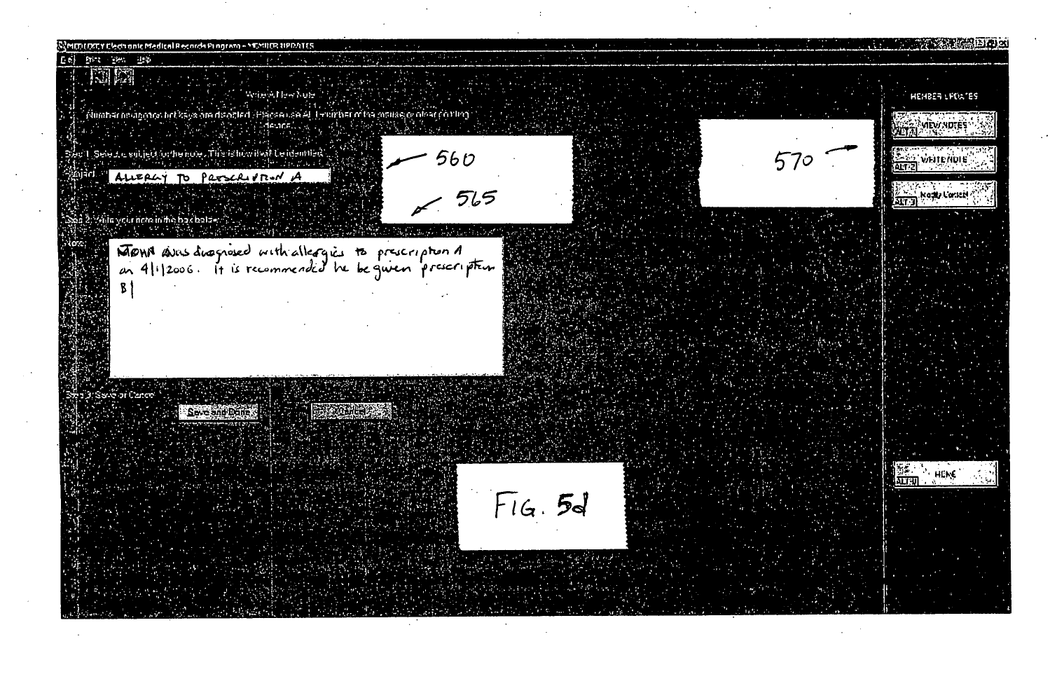

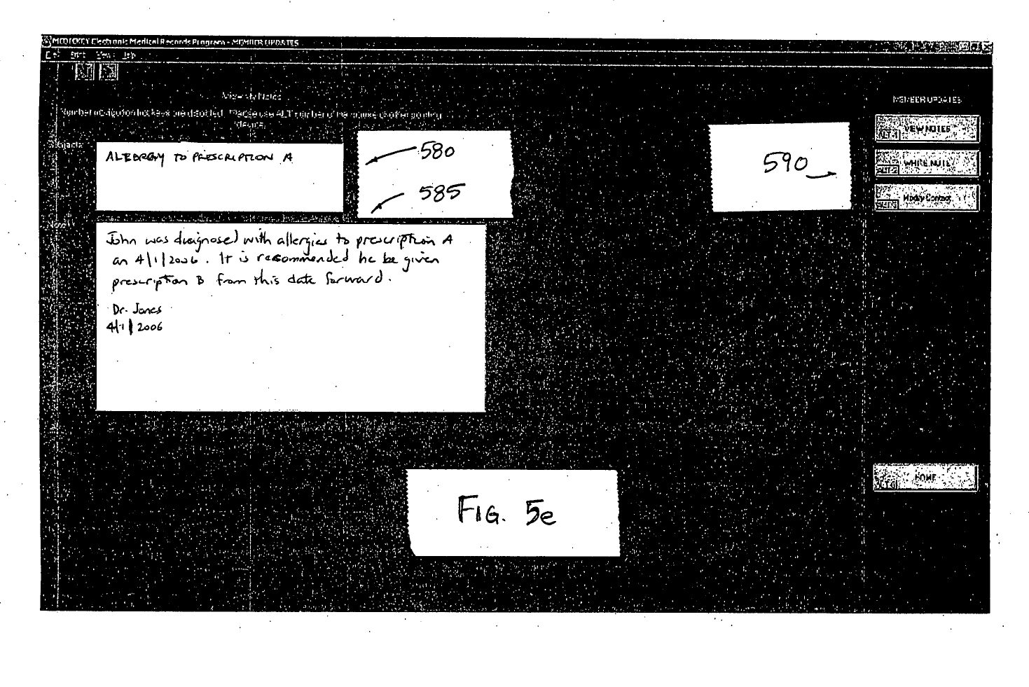

FIGS. 5a-5d illustrate example screen shots displayable on a computer screen inn accordance with one embodiment of the present invention. FIG. 5a illustrates an embodiment of an introductory (or base) screen that is rendered (or presented or displayed) when the portable device 210 is inserted into a universal serial bus (USB) port on a host system.

The introductory screen includes base data such as name, address, telephone number and/or email, and “last updated” information 510, a photograph 512, notice information 515, and menu or button options 520. The notice information 515 includes information about what type of data is on the portable device 210 (or key) and its use. The menu or button options 520 are configured to display screens that are associated with the particular menu or button option, for example, member information (e.g., basic information about the member user such as legal name, address, contact data, next of kin, health insurance data), legal documents (e.g., power of attorney), physician records (e.g., original records that are imaged and stored on the portable device from previous doctor visits), laboratory records (e.g., original laboratory reports that are imaged and stored on the portable device from prior medical laboratory tests), medication records (e.g., information on past and current medications and doses) and the like.

FIG. 5b illustrates one embodiment of a member information screenshot (e.g., which may be rendered in response to its selection (520) from the introductory screen. The member information includes one or more images 525 of the original records data completed by the member user when the portable device 210 data was initially built. If more than one image is present, arrow navigation keys 530 may be used to flip or move between them. The member information screen also includes one or more menus or buttons 535 for rendering additional screens with records or data, for example, images of original insurance cards or member identification cards. Because the data is in image format, and protected (e.g., cannot be written over), the data presented could not be manipulated from the time it was initially entered and verified as noted above. Hence, the user now using the data has assurances as to its accuracy and authenticity.

FIG. 5c illustrates one embodiment of a member information update screen. The member information update screen includes fields 545 for update member information such as address and phone number data. This information can later be synchronized between the portable device 210 and servers at the medical information management system 112. The member information update screen also includes one or more menus or buttons 550 to view, add, or modify data. Note that this information is separate from the original images and original data on the portable device 210. It occupies a third area of a storage that is modifiable by the user, but which cannot overwrite or otherwise change the other areas of storage that should not be modified so that data integrity is maintained.

FIG. 5d illustrates one embodiment of a presented screen where notes can be entered into the system (e.g., write notes). Using a conventional keyboard on a computer system to which the portable device 210 couples, a subject line 560 and notes section 565 can have text data entered and saved. FIG. 5e illustrates one embodiment of a presented screen where the written data is later viewed (e.g., view notes). It is noted that this data is modifiable by a user of the device. In some embodiments, this data may be synchronized with servers at the medical information management system 112 and moved to an area of the portable device 210 where it no longer can be modified.

The present invention beneficially provides a system in which original medical information is placed on a portable device 210 (or key) so that a user may keep that device with them. By including data directly from medical organization originated sources, e.g., hospitals or physician offices, risks associated with improper keying of data is reduced or eliminated. In addition, by having original medical images and original document images on the key device provide first responders and other subsequent tending medical personnel quick access to vital medical information once they have access to the portable device. Moreover, encrypting and securing all original data on the device reduces or eliminates risks of inadvertent or malicious alteration of such information and helps ensure overall data integrity for all.

As used herein, references to “medical” include any medical related field and associated information, for example, medical, dental, vision, chiropractic, therapeutic, and the like. Further, the features and advantages described in the specification provide a beneficial use to those making use of a system and a method as described in embodiments herein. For example, a user is provided mechanisms, e.g., by receiving and/or transmitting control signals, to control access to particular information as described herein. Further, these benefits accrue regardless of whether all or portions of components, e.g., server systems, to support their functionality are located locally or remotely relative to the user.

With a USB interface, the self-contained portable data management key is configured to be a plug-and-play device. The self-contained portable data management device 210 (or key) is configured to be intuitive software which does not require the use of external pointing devices such as a mouse. For example the keyboard keypad can also be used to navigate through the self-contained portable data management key.

The principles disclosed herein beneficially operate differently from other key type devices. Unlike conventional key type devices that are pluggable and portable, the self-contained portable data management device 210 in accordance with the embodiments disclosed herein includes secure area controls its own environment and allows an end user to access the data. This alleviates margins for error. In addition, unlike conventional key type device, the data is accessible through a self-executing runtime program that is incorporated on the self-contained portable data management key within a secure area of the device to prevent unauthorized access and hacking.

Further, the self-contained portable data a management key in accordance with the embodiments disclosed herein couples the incessant need for medical information portability with an easy to use, intuitive mechanism that is also a Citrix safe apparatus and a secure electronic data storage apparatus. It is noted that in a Citrix type configuration, the device receiving the portable device 210 may be a terminal type configuration that uses a secured socket layer (SSL) or transport layer security (TLS) connection with a centralized hosting system. In that configuration, the portable device 210 continues to be operable provided that the port receiving the portable device 210 is functional.

Those skilled in the art will recognize that the principles disclosed herein are applicable to other applications of self contained portable data management configurations. For example, the principles disclosed herein can be used to structure a financial key that can store financial statements, net worth statements, and tax information, scanned upon end user request directly from the financial institutions that keep such data and that may incorporate a process similar to that disclosed herein.

In another example, there may be an executor key that is configured to function in situations such as post death or where a person is mentally incapacitated. For example, the self-contained portable data management key can be structured to store original legal documents such as trusts, wills, and powers of attorney for use by attorneys or other legal entities having authority to proceed on behalf of the key holder.

In yet another example, there may be a passport key that is configured to include vital travel documents in original form as images on the key. For example, the passport key may include a passport image, associated visa or authorized travel documents. The passport key can be configured for issuance by official government bodies that supply the key. It also may be configured to include additional security mechanisms such as biometric data to ensure that the passport key is appropriately in the possession of the key holder. In addition, other optional travel data can be included such as essential medical (including pharmaceutical prescriptions) information as described above.

By way of example, associated with the passport key (either separate or integrated) may be a travel key. The travel key may be configured to provide travelers a single mechanism for integrating travel documents. This may include airline tickets, hotel reservations, and auto-rentals. It also may include other original documents that can supersede the need for actual physical documents, for example, travel insurance documents and tickets or passes to events or attractions. Optional information may include rapid access to related information such as travel itineraries and suggested dining locations. In such embodiments, the keys can be generated and provided through organizations such as travel agencies or other travel package providers (e.g., airline or hotel organizations providing travel or business package services). Again, the self contained configuration of the self-contained portable data management program (or application) disclosed herein maintains core security and authenticity with respect to the documents provided therein.

Similarly, by way of example, there may be a marketing key that can be configured for use by marketing professionals to provide marketing information, for example PowerPoint, video, sound, white papers, resumes, technical manuals, is, all relative to their corporation and the small safe secure device.

In still another example, a first responder key can be configured key in conjunction with a self-contained portable data management program. The first responder key can be structured for use by governmental agencies to provide rapid access to identification and authorization information in the event of emergency situations (e.g., fire or police), national disaster, or the like.

In the various embodiments, it is again noted that data to be secured remains secured and corresponds to the original data from when the key was initially configured or created or was updated in accordance with authorization. In addition, each embodiment also is configured to include a self-executing program so that subsequent devices need not have a copy of an application necessary to access the secured (e.g., encrypted) information. The self-executing program includes the appropriate mechanisms to access, navigate, and otherwise interact with the data on the portable device.

It is noted that the data on the portable device may be secured using conventional mechanisms. For example, conventional encryption programs such as PGP, DES/DES3 and conventional ciphers may be used to secure the data. Conventional decryption mechanisms can then be integrated with the self-contained program for decrypting the data secured using such conventional mechanisms.

Overall, the self-contained portable data management program as structured in a key configuration allows for rapid and immediate access to identifying information where such information may normally take hours, days, weeks or even months from traditional authorization channels that must locate and forward appropriate documentation to the organization or organizations in need. The present invention as disclosed herein beneficially provides accurate, secured and authentic access to such information to emergency medical technicians paramedics, doctors, hospitals government agencies, school systems, travel agencies and the like regardless of location within the world.

It is noted that although the embodiments disclosed herein reference a universal serial bus (USB) configuration, other interfaces also may be used that provide functionality and operability similar to a USB port (e.g., allows the port to detect the presence of a device and interact with applications on that device).

Numerous specific details have been set forth herein to provide a thorough understanding of the embodiments. It will be understood by those skilled in the art, however, that the embodiments may be practiced without these specific details. In other instances, well-known operations, components and logical configurations have not been described in detail so as not to obscure the embodiments. It can be appreciated that the specific structural and functional details disclosed herein may be representative and do not necessarily limit the scope of the embodiments.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

The software, for example, executing on the server, may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments of processes, for example, executing on the disclosed medical information management system or the computer system/terminal receiving the key device, may be implemented, for example, using any computer-readable media, machine-readable media, or article capable of storing software. The media or article (particularly for storing program code) may include any suitable type of memory unit, memory device, memory article, memory medium, storage device, storage article, storage medium and/or storage unit, such as any of the examples described with reference to a memory. The media or article may comprise memory, removable or non-removable media, erasable or non-erasable media, writeable or re-writeable media; digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of embodiments of the present invention. This was done merely for convenience and to give a general sense of the embodiments of the present invention. This description should be read to include one or at least one and the singular also includes the plural unless it is obvious that it is meant otherwise.

Upon reading this disclosure, those of skill in the art will appreciate still additional alternative structural and functional designs for a system and a process for self contained portable medical management key through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A portable device configured to store medical information of a user, the device comprising:
a data storage configured to include a first storage area configured to store medical information corresponding to the user; and
a program product, generated by a centralized medical records repository and stored within a second area of the data storage, the program product configured to execute in a processor of a host system in response to the device being inserted into a memory reader port of the host system,
render a graphical user interface to present the stored medical information on a screen communicatively coupled with the host system,
prevent altering of the stored medical information, and
store additional information in a third area of the data storage in response to receiving data inputted from the host system.

2. The device of claim A1, wherein the stored medical information comprises a true image of an original medical document.

3. The device of claim A1, wherein the stored medical information includes original data inputted by a medical records system.

4. The device of claim A1, wherein the program product is Unicode compliant.

5. The device of claim A1, wherein the program product is further configured to use only an operating system and a random access memory of the host system.

6. The device of claim A1, wherein the memory reader port comprises one of a universal serial bus drive and a flash memory card.

7. A portable device, configured to include stored images corresponding to confirmed original documentation, the portable device comprising:
a data storage configured to include a first storage area to store the confirmed original documentation, the confirmed original documentation from a source that provides the original documentation or authorized to provide the original documentation; and
a program product stored within a second area of the data storage, the program product configured to
execute in a processor of a host system in response to the device being inserted into a memory reader port of the host system,
render a graphical user interface to present the confirmed original documentation on a screen communicatively coupled with the host system,
prevent altering of the confirmed original documentation, and
store additional information in a third area of the data storage in response to receiving data inputted from the host system.

8. The device of claim 7, wherein the program product is Unicode compliant.

9. The device of claim 7, wherein the program product is further configured to use only an operating system and a random access memory of the host system.

10. The device of claim 7, wherein the memory reader port comprises one of a universal serial bus drive and a flash memory card.

11. A method for self executing an application stored on a portable universal serial bus device, the method comprising:
detecting the universal serial bus device in response to communicatively coupling a user system;
preparing a processor resource for execution in response to the portable universal serial bus device being successfully detected;
allocating a drive assignment to the portable universal serial bus device;
identifying an executable for a user program on the portable universal serial bus device; and
executing the identified executable, the executable displaying a user interface corresponding to the user program on a screen corresponding to the user system receiving the portable universal serial bus device.

12. The method of claim 11, further comprising accessing a configuration file in response to executing the identified executable, the configuration file including a mapping to data within a storage area of the portable universal serial bus device.

13. The method of claim 12, further comprising retrieving an encrypted file from the storage area.

14. The method of claim 13, further comprising decrypting the encrypted file and displaying a contents of the decrypted file on the screen corresponding to the user system.

15. The method of claim 14, wherein the accessing, retrieving and decrypting are performed using resources of the user system.

16. The method of claim 12, wherein the portable universal serial bus device is associated with a specific owner.

17. The method of claim 16, wherein the data comprises images of original medical records corresponding to the specific owner.

18. The method of claim 17, wherein the data further comprises verified demographic data corresponding to the specific owner of the portable universal serial bus device.
